(19) United States
(12) Patent Application Publication
(10) Pub. No.: US 2012/0323759 A1
(43) Pub. Date: Dec. 20, 2012

(54) Money Market Trading Platform

(75) Inventors: George W. Hagerman, Denver, CO (US); Matthew Crooks, Littleton, CO (US); Kevin Sun, Highlands Ranch, CO (US)

(73) Assignee: CACHEMATRIX TECHNOLOGY SERVICES LLC, Denver, CO (US)

(21) Appl. No.: 13/610,090

(22) Filed: Sep. 11, 2012

Related U.S. Application Data
(63) Continuation of application No. 13/178,549, filed on Jul. 8, 2011.
Application No. 13/178,549 is a continuation-in-part of application No. 11/071,064, filed on Mar. 3, 2005, now Pat. No. 7,983,969.

(51) Int. Cl. G06Q 40/04

(52) U.S. Cl. 705/37

(57) ABSTRACT

A money market trading platform provides institutional investors with comprehensive on-line analysis, account management, and on-line money market trading capabilities. An institutional investor's computer is connected via a communication network to a bank or broker's computer. The bank or broker's computer is connected via a communication network to a money market trading system or to a financial services, and stores information about the institutional investor and the accounts held in that investor's name. The trading platform allows institutional investors to log on, check account balances, transfer funds within accounts and from outside accounts, research money market investments, and purchase, redeem and exchange shares of money market funds.

### CROSS-REFERENCE TO RELATED APPLICATION

This application is a continuation of U.S. patent application Ser. No. 13/178,549, filed Jul. 8, 2011, which is a continuation-in-part of U.S. patent application Ser. No. 11/071,064 filed Mar. 3, 2005, now U.S. Pat. No. 7,983,969, issued Jul. 19, 2011, which are herein incorporated by reference as if set forth in their entireties.

### TECHNICAL FIELD

This invention relates to trading platforms for institutional investors, and more particularly to money market trading platforms for institutional investors.

### BACKGROUND

Institutional investors are investors that trade on behalf of institutional clients such as corporations, labor unions, retirement funds, and college savings or 529 plans. The trading habits and needs of institutional investors are quite different from the trading habits and needs of individual investors. For example, institutional investors generally manage large sums of money, and consequently daily purchase and redeem millions and tens of millions of dollars worth of money market funds. Similarly, institutional investors are often active market participants, and possess expert knowledge about the markets in which they trade. They often use that knowledge to capitalize on breaking news that effects market valuations and performance. Given the size and volume of their daily trading activity, settling the accounts of institutional investors often requires regular transfers of large amounts of cash. This is usually done via an electronic fund or wire transfer, and separate wire transfers are generally required every time a fund is purchased. Thus, when several fund purchases are made throughout a trading day, several wire transfers are required to settle those purchase transactions. Institutional investors are also subject to regulatory restrictions not placed on ordinary investors, which put limits on how institutional investors can invest their funds. As a result, they often need to know certain information that non-institutional investors do not need to know. For example, to ensure compliance with self-regulatory rules, institutional investors often need to know the relative size of the positions they take in given money market funds. While securities trading systems are known in the art, none are generally designed to provide the types of information and functionality that are needed by institutional investors, and particularly by institutional investors who trade in money market funds.

### SUMMARY

A money market trading platform implemented as a computer program running on a computer is configured to deliver information to an institutional money market investor. The information delivered to the investor may include one or more of the following: the percentage of a money market fund that is owned by the institutional investor, a daily sub total of the purchases made by the institutional investor that require settlement, or the names of first and second money market funds between which the institutional investor can exchange money or funds.

In one aspect, the money market trading platform provides a method for aggregating a plurality of money market purchases made by an institutional investor in the course of a trading day. The method involves receiving a plurality of requests to purchase one or more money market funds; determining the amount needed to make each purchase in each of the plurality of requests, and adding the amount to a daily purchase sub-total. At the end of the trading day, the institutional investor can settle his or her account in a single transaction, e.g., by making a single wire-transfer payment in the amount of the daily purchase sub-total.

In another aspect, the money market trading platform provides a method for determining the percentage of a money market fund that is owned by an institutional investor. The method involves receiving a number representing the current assets under management for a money market fund in which the institutional investor has a position; receiving a number representing the current amount of money the institutional investor has invested in the money market fund; and dividing the number representing the current amount the institutional investor has invested in the money market fund by the number representing the current assets under management for the money market fund.

In another aspect, the money market trading platform provides a method for allowing an institutional investor to exchange shares held in money market funds. The method involves receiving a request from an institutional investor to exchange shares in a first money market fund for shares in a second money market fund, and verifying that the investor has enough invested in the first money market fund to cover the amount sought to be purchased in the second money market fund. Upon verifying that the investor has enough vested in the first money market fund, the method involves redeeming the requested amount in the first money market fund, and using the proceeds to purchase the same amount in the second money market fund.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow chart depicting a method for determining the percentage of a money market fund that is owned by an institutional investor.

FIG. 2 is a flow chart depicting a method for aggregating the money market purchases of an institutional investor, thereby allowing the investor to settle his or her account a single time for the aggregate purchase amount.

FIG. 3 is a flow chart depicting a method for allowing an institutional investor to exchange money market funds.

FIG. 4 is a screen shot showing an “Account” details section of one embodiment of the trading platform.

FIG. 5 is a screen shot showing a “Fund” comparison section of one embodiment of the trading platform.

FIG. 6 is a screen shot showing a “Trading” funds section of one embodiment of the trading platform.

Like reference symbols in the various drawings indicate like elements.

### DETAILED DESCRIPTION

The money market trading platform of the present invention provides institutional investors with comprehensive on-line analysis, account management, and on-line money market trading capabilities. It also allows institutional investors to exchange or transfer money from one money market fund to another. In one embodiment, an institutional investor's computer workstation is connected via the Internet or other communication network to a bank or broker's computer system. The bank or broker's computer system is in turn connected through the Internet or other communication network to one or more money market funds or money market trading systems. The bank or broker maintains an omnibus account for placing trades with the one or more money market funds or money market trading systems, and maintains information about each institutional investor, and information about each investor's accounts on its computer or computer system.

In one aspect, the trading platform of the present invention allows an institutional investor or user to log onto the trading platform with a unique user identifier (“user ID”) and password. Once logged on, the user can check account balances, transfer funds from outside accounts (e.g., via wire transfer), research potential money market investments, and purchase, redeem and exchange shares of money market funds. In one embodiment, the money market activities, transactions, and other functionality available to the user or institutional investor are suitably displayed or made accessible via a graphical user interface. The interface allows the user to view interrelationships between financial information and financial operations, and thereby facilitates analysis and financial transactions that are based, at least in part, on viewing the financial information and operational interrelationships.

Once logged-on, the trading platform provides useful account information to users (institutional investors). The account information includes the names and numbers of all of the accounts that are owned by the user, and the balance of the portfolio managed by the user (i.e., the sum of all of the money that is held in all of the user's accounts). For example, the trading platform can provide information indicating that an institutional investor has two accounts worth a total of approximately $795 million dollars—a pension fund account worth approximately $545 million dollars and a self-insurance account worth approximately $250 million dollars. For each of the investors accounts, the trading platform displays the date the account was opened, a portion of the tax identification number associated with the account, the names of all of the money market funds in which positions are held, the amount of money held in each money market fund, and the total amount of money held in the account. The trading platform allows institutional investors to research and purchase money market funds. Funds can be researched by displaying all of the funds available for purchase through the bank or broker, or by displaying only those funds that satisfy certain filter criteria. Displayed funds are generally displayed together with the criteria that are used to filter the funds. These criteria can include the names of the funds, their ticker symbols, their CUSIP identifiers, the total assets under management (“AUM”) for the fund, the current amount of the fund that is owned by the user (e.g., in both absolute terms and as a percentage of AUM), the 1-day, 7-day, and 30-day fund yields, various fund ratings (e.g., Moody's, S&P, Fitch & NAIC), the type of fund (e.g., prime, municipal or treasury), the fund's date of inception, expense ratio, etcetera. Displayed funds can generally be sorted by the filter criteria. For example, the funds can be sorted in ascending or descending order to show which funds have the highest or lowest 7-day effective yield.

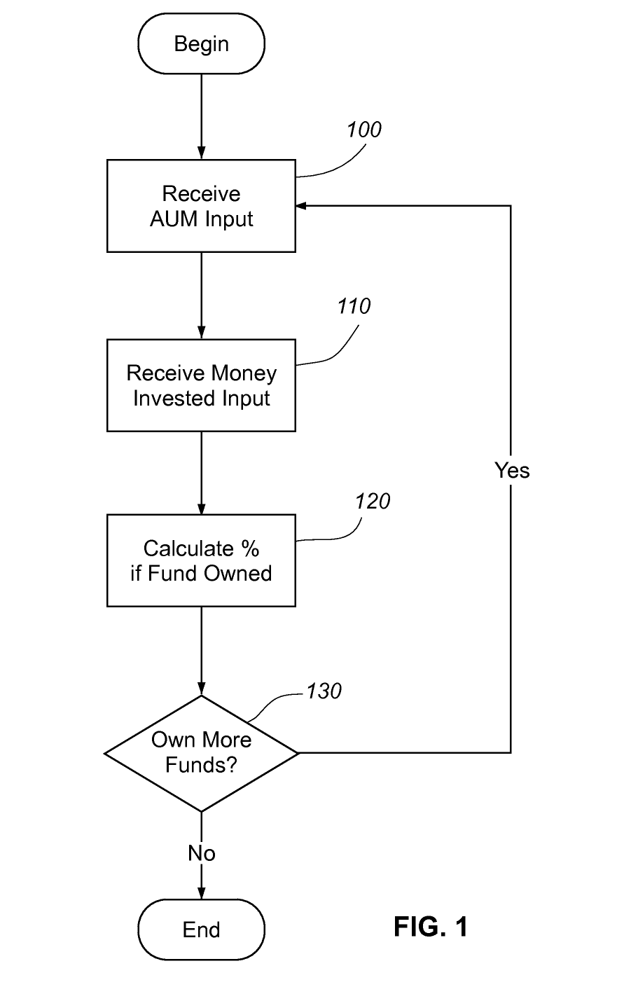

Among the information the trading platform can display to a user or institutional investor is the percentage of each fund that is owned by that investor. The trading platform determines this percentage as shown in FIG. 1. On a periodic basis, which is typically daily, the trading platform receives input from each money market fund that can be traded indicating the total assets that fund currently has under management. This information can be stored in a database that is associated with the trading platform, or it can be retrieved whenever an institutional investor requests a display of the percentage of funds owned. The trading platform determines the percentage of each fund owned by receiving input for each fund indicating that fund's current assets under management (step 100) and the amount of money the investor currently has invested in the fund (step 110). After determining the current assets under management and the amount the investor has invested in a fund, the platform determines the percentage of the fund owned by dividing the amount invested by the assets under management (step 120). The trading platform calculates and displays this percentage for each money market fund that is owned by the investor (step 130). When the investor maintains multiple accounts, the trading platform determines the percentage of fund owned for each of the investor's accounts. By determining and displaying the percentage of funds owned, the trading platform provides institutional investors with the needed means to monitor and ensure compliance with applicable regulatory rules, such as self-regulatory rules.

The trading platform also allows institutional investors to trade shares in one or more of the available money market funds by placing orders to purchase, redeem, or exchange shares. The orders can be placed, for example, by selecting an item in a drop down transaction menu that appears next to each fund's name. When the investor elects to redeem fund shares, the trading platform provides a text box, drop down menu, or other similar means for the investor to indicate the dollar amount that the investor wishes to redeem. The trading platform also provides a text box, drop down menu or other suitable means to allow the investor to identify the bank account to which the investor wishes the redemption proceeds to be deposited.

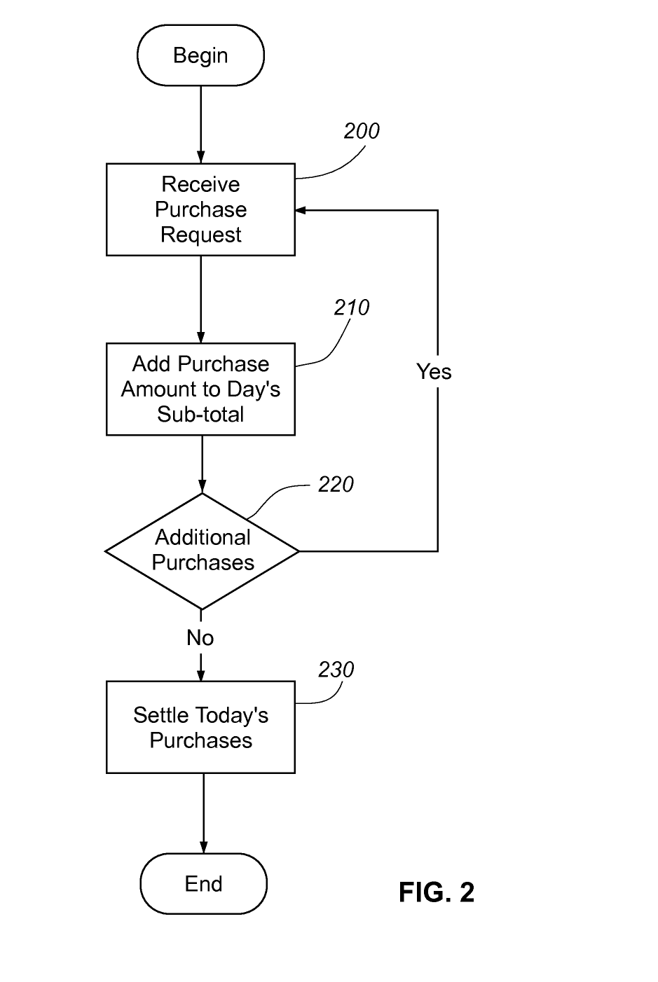

When the investor elects to purchase shares, the trading platform provides a text box, drop down menu or other means for the investor to indicate the dollar amount of the fund that the investor wishes to purchase. The trading platform allows an investor to make multiple fund purchases over the course of a trading day, and to aggregate those purchases so that the investor can settle his or her account a single time at the end of the trading day via a single wire transfer. In one embodiment, as shown in FIG. 2, when the trading platform receives a purchase request (step 200), it adds the current purchase amount to a daily purchase sub-total (step 210). If additional purchases are made throughout the day (step 220), the trading platform receives those additional purchase requests (step 200), and adds the additional purchase amounts to the daily purchase sub total (step 210). As a result, at the end of the trading day, the trading platform can determine the amount needed to settle the institutional investors account (step 230). This allows an institutional investor to settle his or her account in a single transaction, by ordering a single wire transfer in the amount of the final daily purchase sub-total, while making one or more purchases from one or more mutual funds throughout the trading day.

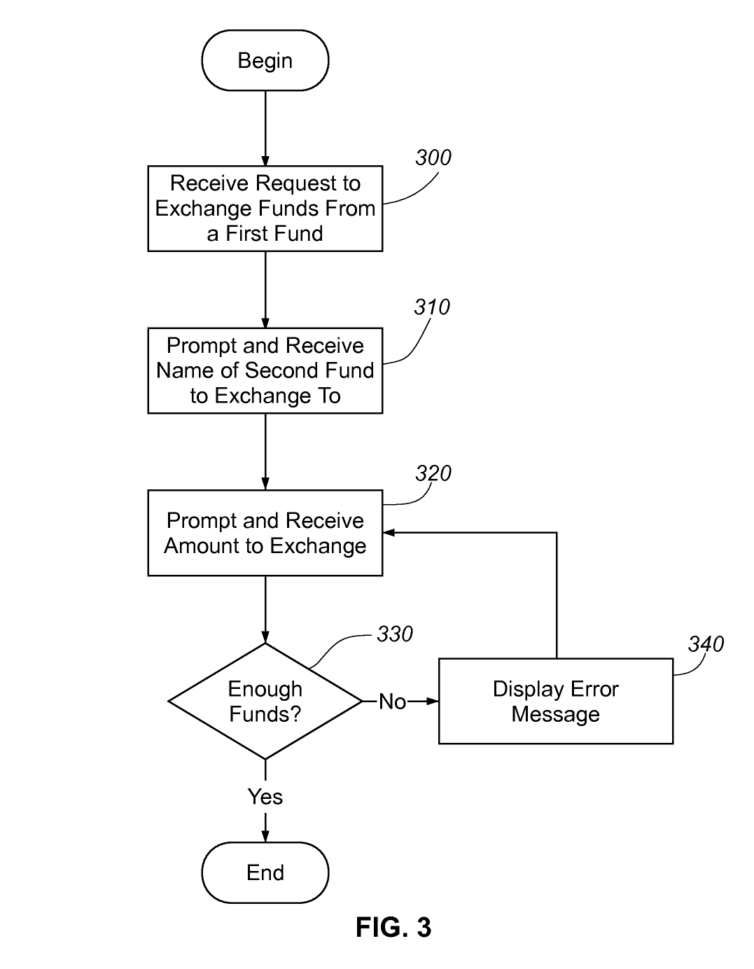

The trading platform also allows an institutional investor to exchange funds from one money market fund to another money market fund without depositing additional funds into his or her account. For example, as shown in an embodiment depicted in FIG. 3, the trading platform is configured to receive an investor request to exchange funds from a first money market fund (step 300). Upon receiving the request, the trading platform provides the investor with a text box, drop down menu or other means to indicate the name of a second money market fund in which the investor wishes to take a position by exchanging shares from the first money market fund (step 310). The trading platform then provides the investor with a text box, drop down menu or other means to indicate the dollar amount of funds that the investor wishes to exchange from the first money market fund to the second money market fund (step 320). Next, the trading platform verifies that the investor has a large enough position in the first money market fund to allow the desired exchange from the first money market fund to the second money market fund (step 330). If the first money market fund does not have sufficient funds, an error message is displayed (step 340), and the user is again prompted to enter a new dollar amount (step 320). When the investor enters a dollar amount that can be covered by the investor's position in the first money market fund, the trading platform completes the exchange of funds from the first money market fund to the second money market fund, without requiring a deposit of additional funds into the investor's account.

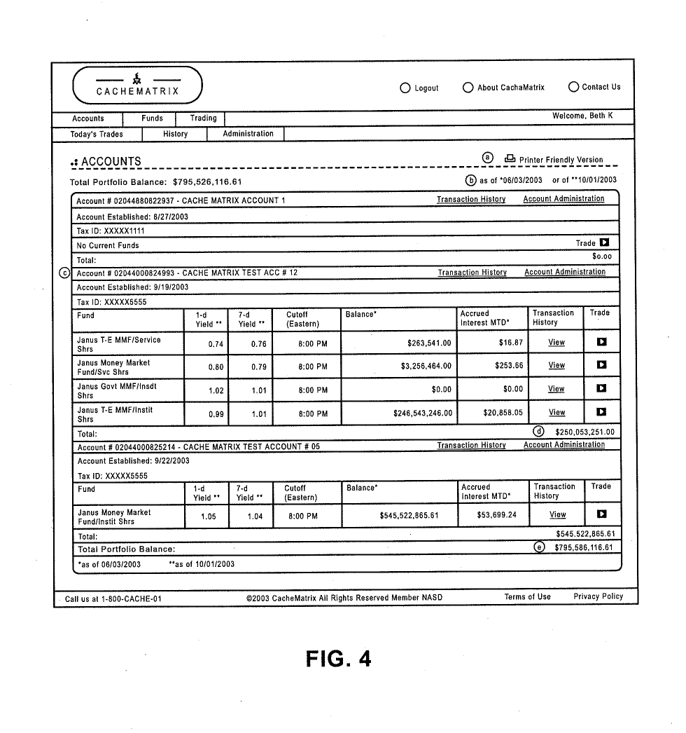

Each of the features of the money market trading platform described herein are accessible through interrelated areas that are displayed together or in a logical fashion as a web of linked documents. In one embodiment, each feature is available in a document that can be displayed to an institutional investor via a web browser or other suitable graphical user interface. For example, as shown in FIG. 4, the trading platform can display user account information such as the number and type of accounts, the holdings and total value of each account, and the total holdings in all accounts to an institutional investor that successfully logs-on to the trading platform. From the user account page, the institutional investor can administer his or her account through the “Administration” tab, review that days transactions through the “Today's Trades” tab, review even more transaction history through the “History” tab, search money market funds through the “Funds” tab, or trade funds through the “Trading” tab.

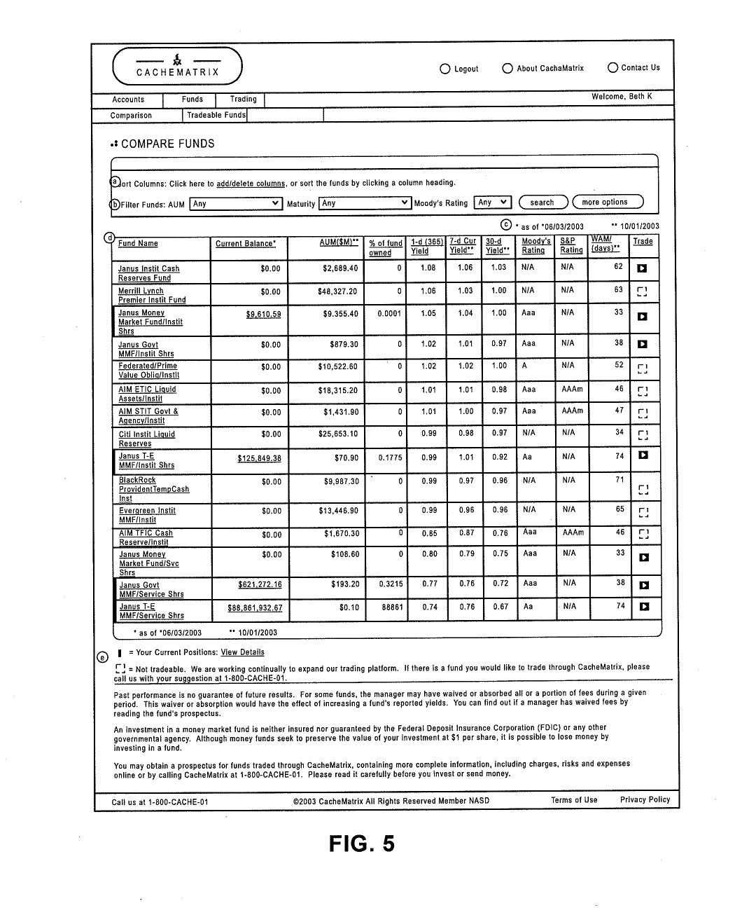

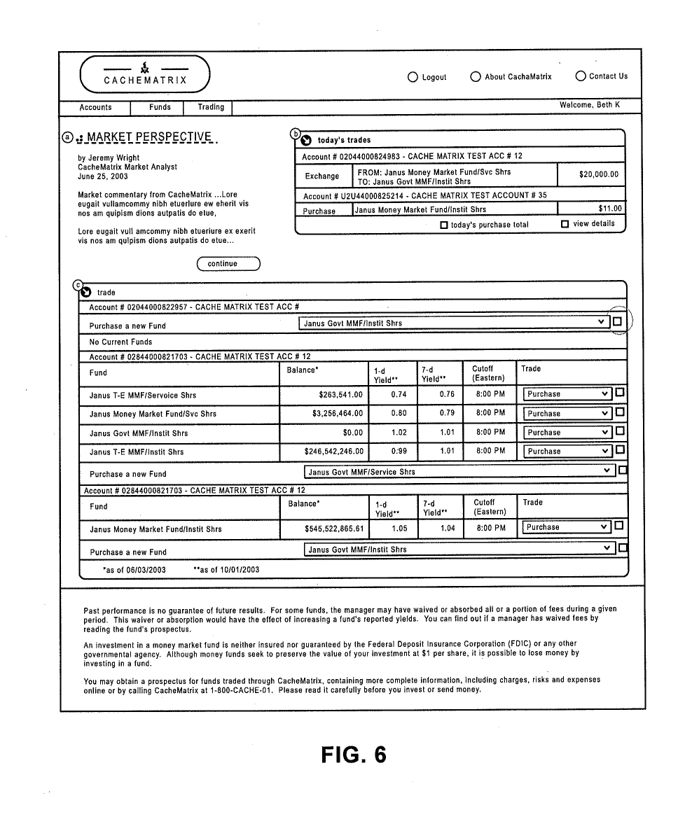

As shown in FIG. 5, the trading platform allows an institutional investor to research all of the funds that are available for trading by selecting the “Funds” tab. When the “Funds” tab is selected, various information such as the money market fund name, current assets under management, and 1-day and 7-day yields are displayed. The institutional investor can customize the type of information that is displayed by adding or deleting columns of information. The institutional investor can also use the information that is displayed to filter, find, and display only those money market funds that are of interest to him or her. For example, the institutional investor can filter, find and display only those funds that are rated AAA by Moody's and that have more than $5 billion dollars in assets under management. From the “Funds” tab, the institutional investor can return to the “Accounts” tab to display all account information, or can select the “Trading” tab to purchase, redeem, or exchange money market funds. As shown in FIG. 6, upon selecting the “Trading” tab, the institutional investor is presented with a summary of the day's trading activity, a drop down menu that allows the institutional investor to purchase a money market fund from a list of funds, and a list of account holdings. The list of account holdings includes a drop down menu that allows the institutional investor to alter his or her current account positions by purchasing, redeeming or exchanging those money market funds in which the institutional investor currently holds a position. For example, the institutional investor can add to a fund position by purchasing additional money market funds or can liquidate a fund position by redeeming all of the shares held in that money market fund. Upon purchasing additional money market funds, the trading platform displays a pop-up menu that shows the current daily purchase sub-total. By running and displaying a daily purchase sub-total, the trading platform allows the institutional investor to settle the days current trading activity by making a single wire transfer payment in the amount of the daily purchase sub-total as explained above with respect to FIG. 2.

The trading platform of the present invention is implemented on a bank or broker's computer or computer system. The bank or broker will generally maintain an omnibus account with one or more money market funds or money market trading systems to give the bank or broker's institutional investor clients access to the money market funds that are offered through the trading portal. When an institutional investor buys or redeems shares of a money market fund through the trading portal, the bank or broker purchases or redeems shares of that money market fund on behalf of the institutional investor by placing appropriate orders through its omnibus account. Because all money market fund purchases, redemptions and exchanges entered by institutional investor's through the trading portal are ultimately placed through the bank or broker's omnibus account, the bank or broker can net-out or conglomerate all of the orders placed by its institutional investor clients to each money market fund that is available for trading, and make a single or net trade with each fund to balance the bank or broker's omnibus account. In this way, the content of the bank or broker's omnibus account will reflect the net holdings of the institutional investor accounts that have access to and trade money market funds through the trading portal.

The trading platform can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The trading platform can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory.

Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the trading platform can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. For example, the steps of the invention can be performed in a different order and still achieve desirable results. While the trading platform was described in terms of a series of linked documents, the available features can be presented in a single viewable area such as in a single viewable document or a single window with multiple window panes. While the trading platform was described as being viewable through a custom graphical user interface, the platform can also be viewable through a convention web browser such as the Internet Explorer or Netscape Navigator web or similar such browsers. Accordingly, these, and other embodiments are within the scope of the following claims.

What is claimed is:

1. A computer-implemented system for an institutional investor to manage positions in money market funds in the institutional investor's accounts, the system comprising at least one processor configured to be able to perform the following steps:
enabling access to account information corresponding to at least one account under management by the institutional investor;
enabling display of the account information in a human perceivable form, wherein the account information enabled for display includes an account name, an account number, a listing of all funds in which the institutional investor has positions in the account, corresponding fund balances, and a total balance of the account;
enabling display of a first user input field, wherein the first field, when activated by the user, initiates a trade, the display of the first user input field enabled to occur simultaneously with the display of the account information;
enabling access to funds available for trading through the system, the access to the funds occurring in response to user activation of a corresponding funds field;
enabling display of fund information corresponding to the funds available for trading through the system, the display enabled so that the fund information appears in a human-perceivable form, the display including indications of fund names, corresponding current balances under management in the account, assets under management, and corresponding percentages of the funds owned by the account;
enabling display of a second user input field for receiving input to request a trade, the display of the second field enabled for display along with the fund information;
enabling a trade of at least one of the funds corresponding to the fund information in response to user activation of the second field.

2. The system of claim 1, wherein the at least one processor is operable, in response to input by the institutional investor, to send a representation of a screen including a sub-total field for displaying a daily purchase sub-total;
wherein the processor is further operable to generate data corresponding to the current daily purchase sub-total; and
wherein the processor is further operable to display the current daily purchase subtotal in the daily purchase sub-total field; and
wherein the processor is further operable to initiate a payment in the amount of the daily purchase sub-total in response to user input.

3. The system of claim 2, wherein at least one processor is configured to request an exchange of monetary amounts from one of the funds for which fund information is displayed for a corresponding position in another of the funds for which fund information is displayed.

4. The system of claim 3, wherein at least one processor is configured, in response to an institutional investor's requesting a trade of at least one of the funds, to aggregate multiple trade requests to determine the daily purchase sub-total; and wherein the processor is further configured to transmit a single payment instruction corresponding to the daily purchase subtotal.

5. The system of claim 1, wherein the system comprises a money market trading platform adapted to access a set of money market funds available from a corresponding banking institution for institutional investors to trade, the platform including at least one microprocessor, the system further including:
at least one data structure electronically accessible to the platform, the data structure having the account information and the fund information resident thereon; and
at least one client device;
wherein the microprocessor is configured to run a computer program, stored in a non-transitory computer-readable storage medium, that instructs the microprocessor to access at least one of the account information and the fund information and send the accessed information to the client device.

6. A computer-implemented money market trading platform for institutional investors to analyze, manage, and perform trades for institutional accounts under management by the institutional investors, the trades comprising purchases and redemptions of positions in money market funds, the platform having at least one computer workstation with a display device and an associated user interface accessible by one of the institutional investors, the money market trading platform comprising:
data structures electronically accessible to the platform, the data structures having resident thereon account information corresponding to at least one account under management by the institutional investor and fund information corresponding to all funds available for trading through the platform, the account information including an account name, an account number, a listing of all funds in which the institutional investor has positions in the account, corresponding fund balances, and a total balance of the account, the fund information including indications of fund names, corresponding current balances under management in the account, assets under management, and corresponding percentages of the funds owned by the account;
a microprocessor configured to run a computer program, stored in a non-transitory computer-readable storage medium, that instructs the microprocessor to access at least one of the account information and the fund information and send the accessed information to the computer workstation;
the microprocessor being further configured to cause to be displayed on the display of the computer workstation a user input field, wherein the user input field, when activated by the user, initiates a trade;
wherein the microprocessor is further configured to enable the display of a table of the funds available for trading through the platform, the corresponding percentages of the funds owned by the account, and the corresponding current balances under management in the account;
wherein the processor is further configured to cause the display of a plurality of user input fields in the table, the user input fields corresponding to respective ones of the funds appearing in the table, the user input fields, when activated by the user, initiating trades of the respective associated fund.

7. The money market trading platform of claim 6, wherein the microprocessor is configured to enable the display of the table on a first electronic sheet, the microprocessor enabling the display of a second electronic sheet displaying: at least one account name, a listing of all funds in which the institutional investor has positions corresponding to the account name, and corresponding balances for said funds.

8. The money market trading platform of claim 7, wherein the microprocessor is configured to enable the display of a third electronic sheet, the third electronic sheet interrelated to the first and second electronic sheets, the microprocessor configured to determine a running total of trades by the institutional investor during a corresponding day, and displaying a corresponding daily subtotal of said trades on the third electronic sheet.

9. The money market trading platform of claim 8, wherein the processor is further configured to enable navigation from one to another of the electronic sheets in response to user activation of corresponding fields on each of the electronic sheets.

10. The money market trading platform of claim 9, wherein the microprocessor is configured to enable the display of at least one of the user input fields on each of the three electronic sheets.

11. The money market trading platform of claim 10, wherein the microprocessor is further configured to enable display of a plurality of the user input fields on each of the electronic sheets, the user input fields associated with corresponding ones of the funds listed on the electronic sheets, wherein the microprocessor is configured so that the user input fields, when activated by the user, initiate the trade of the fund corresponding to the activated user input field.

12. The money market trading platform of claim 11, wherein the microprocessor is configured so that initiation of a trade includes one of a purchase of an increased position in the corresponding fund and a reduction of position in the corresponding fund.

13. The money market trading platform of claim 12, wherein the microprocessor is further configured to enable the display of a filter input field, the filter input field enabled by the microprocessor, in response to user input, to display fund information that satisfies user input related to the fund information.

14. A method for an institutional investor to manage positions in money market funds in an institutional investor's account, the method comprising:
gaining access to all funds available for trading, through a financial institution associated with the institutional investor's accounts, the access to said funds occurring in response to institutional investor activation of a corresponding first input field displayed on a user interface;
causing the display of fund information on the user interface corresponding to all funds available for trading through the financial institution, the display including indications of fund names, corresponding current balances under management in the account, assets under management, and corresponding percentages of the funds owned by the account;
activating a second input field displayed on the user interface at the same time as the fund information, the activation causing a trade to be initiated of at least one of the funds corresponding to the fund information displayed on the user interface.

15. The method of claim 14, further including the steps of:
in response to input through a user interface, gaining access to account information corresponding to at least one account under management by the institutional investor, wherein gaining access causes the display of the account information in a human perceivable form, wherein the account information displayed includes an account name, an account number, a listing of all funds in which the institutional investor has positions in the account, corresponding fund balance, and a total balance of the account;
activating a third input field displayed along with the account information, wherein the third input field, when activated by the user, initiates a trade of at least one of the funds in which the institutional investor has positions in the respective account.

16. The method of claim 14, wherein the institutional investor activates one of a plurality of input fields displayed on a table, the table appearing on the user interface, the plurality of input fields corresponding to respective ones of the funds, the funds also appearing in the table, the user input fields, when activated by the user, initiating trades of the respective, associated funds.
